(19) United States
(12) Patent Application Publication
(10) Pub. No.: US 2005/0141615 A1
(43) Pub. Date: Jun. 30, 2005

(54) Motion vector estimating method and motion vector estimating apparatus using block matching process

(75) Inventor: Tae-hee Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/921,955

(22) Filed: Aug. 20, 2004

(30) Foreign Application Priority Data
Dec. 29, 2003 (KR) 2003-99041

(51) Int. Cl. H04N 7/12

(52) U.S. Cl. 375/240.16; 375/240.24

(57) ABSTRACT

A motion vector estimating method that includes calculating correlation values corresponding to a plurality of correlation calculating patterns selected in accordance with types of a present image, and determining a correlation calculating pattern according to the calculated correlation values; and selecting a sub-sampling pattern corresponding to the determined correlation calculating pattern, sub-sampling a present image block and a search area, and then estimating a motion vector, whereby it is possible to reduce an amount of calculation in estimating a motion vector.

### CROSS-REFERENCE TO RELATED APPLICATION

This application claims the benefit of Korean Patent Application No. 2003-99041, filed on Dec. 29, 2003, in the Korean Intellectual Property Office, the disclosure of which is incorporated herein by reference.

### BACKGROUND OF THE INVENTION

1. Field of the Invention

The present invention relates to encoding and decoding a moving picture or image, and more specifically, to a motion vector estimating method and a motion vector estimating apparatus using a block matching process for encoding a moving picture or image.

2. Description of the Related Art

In general, a motion vector for a certain image block is estimated by determining a search area and detecting an image block most closely matching with pixel values of the desired image block. That is, an image block most similar to the desired image block is detected while moving the desired image block over the search area by a pixel, and a position of the image block is determined as the motion vector. However, since degrees of similarity of the pixel values should be calculated while moving the desired image block over the search area of every pixel, the above method requires a large amount of calculation.

### SUMMARY OF THE INVENTION

Additional aspects and/or advantages of the invention will be set forth in part in the description which follows and, in part, will be obvious from the description, or may be learned by practice of the invention.

Accordingly, an aspect of the invention provides a motion vector estimating method and a motion vector estimating apparatus in which the amount of calculation for estimating a motion vector is reduced by sub-sampling a macroblock and a search area.

According to an aspect of the invention, a motion vector estimating method includes calculating correlation values corresponding to a plurality of correlation calculating patterns selected in accordance with types of a present picture, and determining a correlation calculating pattern on the basis of a calculation result; and selecting a sub-sampling pattern corresponding to the correlation calculating pattern determined in the calculating of the correlation values, sub-sampling a present image block and a search area, and then estimating a motion vector.

An aspect of the motion vector estimating method may further include converting the estimated motion vector into a size corresponding to a size of the search area before the sub-sampling.

An aspect of the calculating of the correlation values includes calculating correlation values of a predetermined pattern selected depending upon whether the present picture is an interlaced picture or a progressive picture; and selecting a pattern of which the calculated correlation value is the smallest.

According to another aspect of the invention, a motion vector estimating apparatus includes a pattern determining unit that calculates correlation values corresponding to a plurality of correlation calculating patterns selected in accordance with types of a present picture, and determines a correlation calculating pattern on the basis of a calculation result; a sub-sampling unit that selects a sub-sampling pattern corresponding to the determined correlation calculating pattern, and sub-samples a present image block and a search area; and a motion vector estimating unit that estimates a motion vector of the sub-sampled image block and the sub-sampled search area.

An aspect of the motion vector estimating unit converts the estimated motion vector into a size corresponding to a size of the search area before the sub-sampling.

An aspect of the pattern determining unit calculates correlation values of a predetermined pattern selected depending upon whether the present picture is an interlaced picture or a progressive picture, and selects a pattern of which the calculated correlation value is the smallest.

An aspect of the sub-sampling unit sub-samples the present image block and the search area by discarding pixels in even lines or odd lines when the determined correlation calculating pattern is a horizontal or vertical pattern, and sub-samples the present image block and the search area by alternately discarding even and odd pixels every line when the determined correlation calculating pattern is a diagonal pattern.

### BRIEF DESCRIPTION OF THE DRAWINGS

The above and/or other features and advantages of the invention will become more apparent and readily appreciated from detailed description of exemplary embodiments thereof with reference to the accompanying drawings in which:

FIG. 1 is a diagram illustrating estimation of a motion vector by using a block matching process according to an aspect of the invention;

FIG. 2 is a diagram illustrating estimation of a motion vector by performing the block matching process on a search area according to an aspect of the invention;

FIG. 3 is a flowchart illustrating a motion vector estimating method according to an aspect of the present invention;

FIGS. 4A through 4D are diagrams illustrating patterns used for calculating correlation values according to an aspect of the invention;

FIGS. 5A through 5C are diagrams illustrating a sub-sampling process according to an aspect of the invention;

FIG. 6 is a block diagram illustrating a motion vector estimating apparatus according to an aspect of the invention; and

FIG. 7 is a diagram of a display apparatus for generating an image to be displayed according to an aspect of the invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

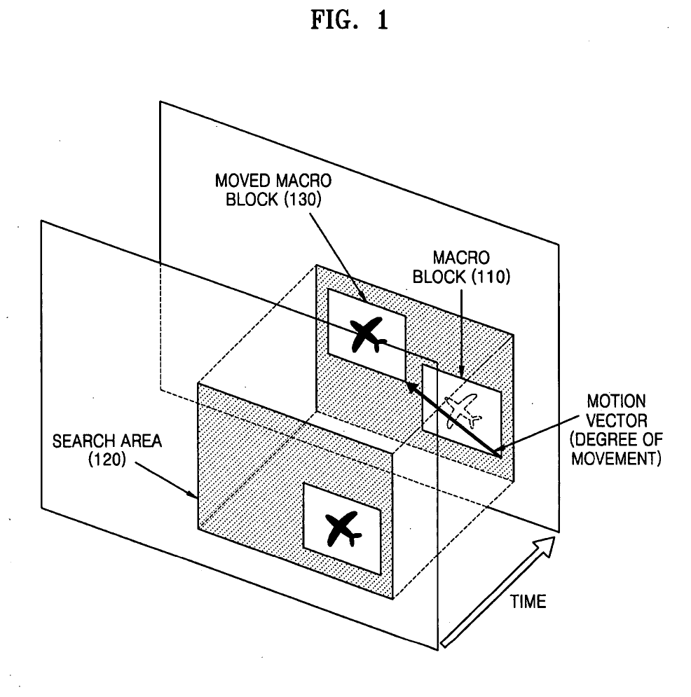

FIG. 1 is a diagram illustrating estimation of a motion vector by using a block matching process according to an aspect of the invention. The image used in FIG. 1 is an airplane shape. When the airplane shape is moved with an advance of time from t₁ to t₂, it is determined how much the airplane shape is moved by searching a predetermined search area 120 for the same shape as the airplane shape. The searching process may be performed in a unit of macroblock 110, and it is found out how much the macroblock 110 is moved. For example, the moved macroblock 130 is detected by determining the search area 120 and searching all of the possible image blocks within the range of the search area 120. A degree of movement of the detected macroblock 130 is considered as a motion vector. The motion vector is dependent on various conditions, such as how the search area 120 is set to and whether the block matching process should be performed on the overall pixels in the search area 120.

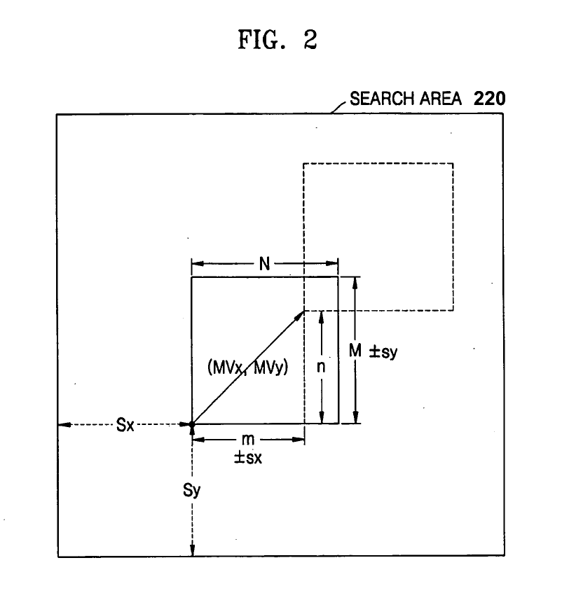

FIG. 2 is a diagram illustrating estimation of a motion vector by performing a block matching process on a search area 220. When estimating a motion vector by using the block matching process, a predetermined search area 220 is defined, sums of absolute differences (SADs) are calculated while moving the macroblock 210 over the search area 220, and an image block of which the SAD is the smallest is detected, thereby determining a motion vector (MVx, MVy) of a k-th macroblock 210. The SADs may be calculated using Equation 1:

$$\begin{matrix}( MVx , MVy ) = arg min {{SAD}_{k}}_{( m , n ) ∈ S} ( m , n ) \\ {SAD}_{k} ( m , n ) = {\sum }_{i = 0}^{16} {\sum }_{j = 0}^{16} \vert {F}_{i , j} - {F}_{i + m , j + n}^{R} \vert\end{matrix} \qquad ( Equation 1 )$$

That is, the SADs are calculated from pixel values of the present image block and the search area while moving the present image block 210 over the search area 220 by m pixels in a horizontal direction and n pixels in a vertical direction. Since the calculation of SAD is carried out to all the pixels in the search area 220, m and n can become ±sx and ±sy, respectively. When the SAD of the image block after movement by m and n pixels is the smallest, (m, n) is a motion vector (MVx, MVy). In this way, the SADs are calculated while moving the present image block 210 over the search area 220. F_{i,j} used in the calculation of SAD is a brightness of a pixel located at an i-th row and a j-th column in a present frame or field, and F^{R}ᵢ₊ₘⱼ₊ₙ is a brightness of a pixel located at an i+m row and a j+n column in a reference frame or field. If the search area for a motion vector is set to ±sx in a horizontal direction and ±sy in a vertical direction, the calculation of SAD should be carried out as many times as (2sx+1)×(2sy+1) so as to estimate a motion vector of one macroblock 210.

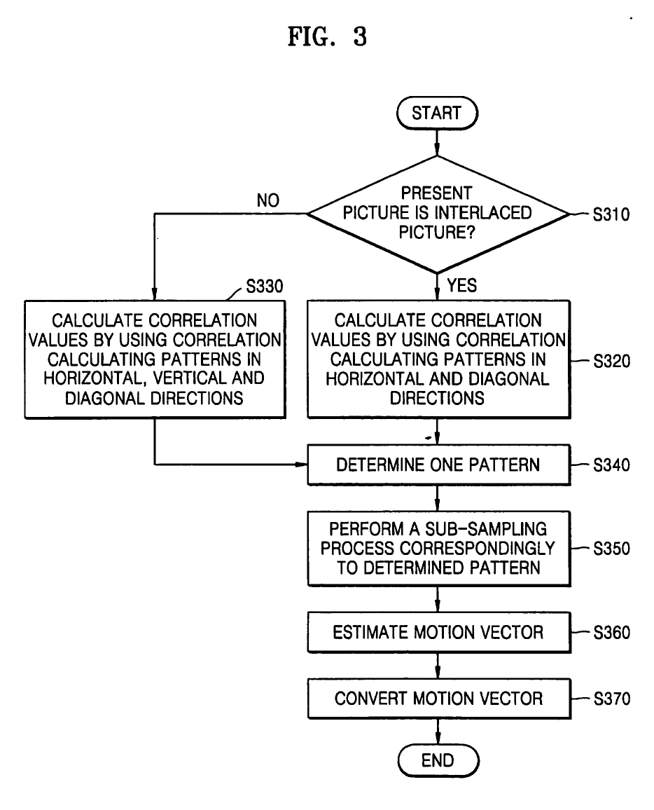

FIG. 3 is a flowchart illustrating a motion vector estimating method according to an aspect of the invention. In operation 310, a type of an input picture is checked. That is, it is determined whether the input picture is an interlaced picture or a progressive picture. In operation 320, when the input picture is the interlaced picture, correlation calculating patterns only in horizontal and diagonal directions are used to calculate the correlation values without using a correlation calculating pattern in a vertical direction. In operation 330, when the input picture is the progressive picture, the correlation calculating patterns in the horizontal, vertical and diagonal directions are used to calculate the correlation values.

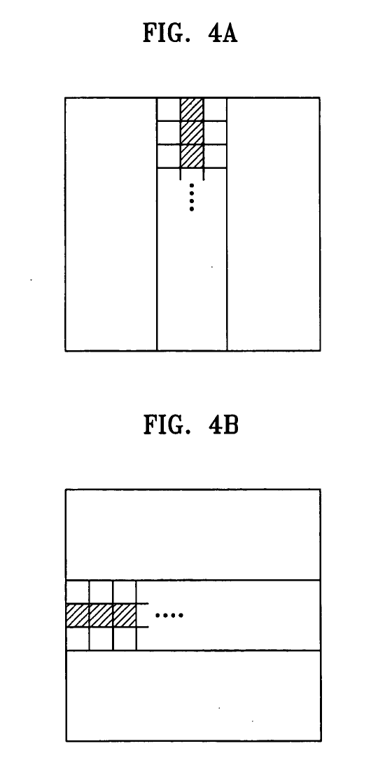

FIGS. 4A through 4D are diagrams illustrating examples of patterns used for calculating the correlation values. When the present picture is the progressive picture, the correlation values are calculated in accordance with the patterns shown in FIGS. 4A through 4D, and when the present picture is the interlaced picture, the correlation values are calculated in accordance with the patterns shown in FIGS. 4B through 4D. In operation 340, one correlation calculating pattern is selected on the basis of the calculation result.

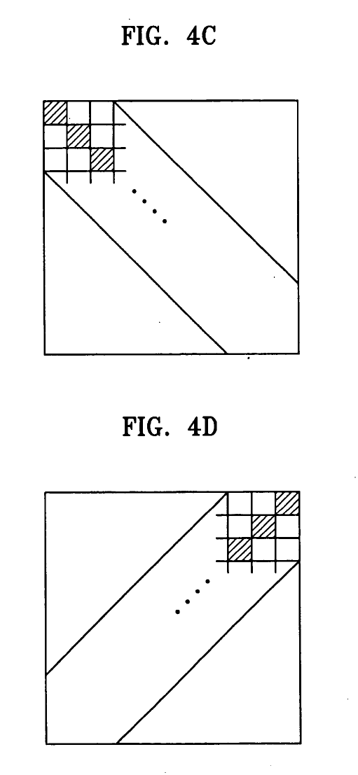

The selection of the correlation calculating pattern is carried out on the basis of the correlation values between the pixels. For example, in the present macro block, the correlation values between the adjacent pixels, using the patterns shown in FIGS. 4A through 4D, are calculated, and the pattern having the smallest correlation value is selected. The calculation of correlation values can be carried out, for example, by using a difference in brightness between a hatched pixel and a pixel adjacent thereto. In operation 350, the search area and the present macroblock are sub-sampled correspondingly with the selected pattern. The sub-sampling process will be described later with reference to FIGS. 5A through 5C. The SAD of the sub-sampled macroblock and the search area is calculated, thereby determining a motion vector. In operation 370, the determined motion vector is converted into a size corresponding to a size of the motion vector before carrying out the sub-sampling process. That is, since the sub-sampling process has been carried out, a size of the original image has been decreased into a half, and thus the size of the motion vector has been decreased into a half, so that the size of the motion vector is doubled to correspond to the size of the original image.

FIGS. 5A through 5C are diagrams illustrating an example of the sub-sampling process. When the vertical correlation calculating pattern shown in FIG. 4A is used, a sub-sampling pattern shown in FIG. 5A is used. When the horizontal correlation calculating pattern shown in FIG. 4B is used, a sub-sampling pattern shown in FIG. 5B is used. When the diagonal correlation calculating pattern shown in FIG. 4C or 4D is used, a sub-sampling pattern shown in FIG. 5C is used.

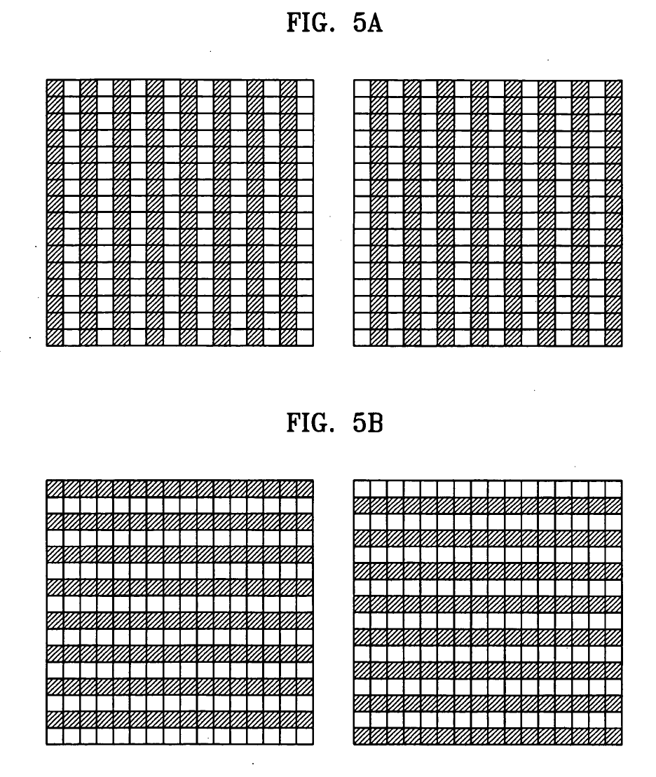

FIG. 6 is a block diagram illustrating a motion vector estimating apparatus 600 according to an aspect of the invention. The motion vector estimating apparatus 600 includes a pattern determining unit 610, a sub-sampling unit 620, and a motion vector estimating unit 630. It is understood that the apparatus can be included in a display in an apparatus used to generate images to be displayed and/or in a computer used to display images. Further, the images can be reproduced from a medium in the apparatus or from the transmitted data.

The pattern determining unit 610 calculates the correlation values corresponding to a plurality of correlation calculating patterns selected in accordance with characteristic data of the present picture, and determines the correlation calculating pattern on the basis of the calculation result. That is, the pattern determining unit 610 calculates the correlation values of a predetermined pattern selected depending upon whether the present picture is an interlaced picture or a progressive picture, and then selects a pattern of which the correlation value is the smallest. The correlation value may relate to either adjacent pixels or a difference in brightness between a hatched pixel and a pixel adjacent thereto.

The sub-sampling unit 620 selects a sub-sampling pattern corresponding to the determined correlation calculating pattern, and sub-samples the present image block and the search area. That is, the sub-sampling unit 620 sub-samples the present image block and the search area by discarding pixels in even lines or odd lines when the determined correlation calculating pattern is the horizontal or vertical pattern, and sub-samples the present image block and the search area by alternately discarding even and odd pixels on every line when the determined correlation calculating pattern is a diagonal pattern. The sub-sampling unit 620 also converts the estimated motion vector into a size corresponding to the size of the search area before carrying out the sub-sampling process. The motion vector estimating unit 630 estimates the motion vector of the sub-sampled image block and the sub-sampled search area. That is, the motion vector is estimated by calculating the SAD between the pixels.

Estimation of the motion vector using the sub-sampling process is described below in more detail. In the left pattern of FIG. 5A or 5B, horizontal pixel components of the macroblock and the search area take odd pixels of the original image through the sub-sampling process, and in the right pattern of FIG. 5A or 5B, horizontal pixel components of the macroblock and the search area take even pixels of the original image through the sub-sampling process. In the pattern of FIG. 5C, the macroblock and the search area alternately take the even pixels and the odd pixels of the original image. The motion vector is determined on the basis of the SAD in the vertical even line and the SAD in the vertical odd line. That is, a horizontal component of the motion vector has the even pixel component or the odd pixel component on the basis of comparison of the two SADs.

The aforementioned motion vector estimating method may be embodied as a computer program read by at least one computer. Codes and code segments constituting the programs can be easily construed by programmers skilled in the art to which the present invention pertains. The motion vector estimating method according to an aspect of the invention is embodied by storing the program on at least one computer readable medium and executing the program on at least one computer. Examples of the computer readable media include magnetic storage medium, optical recording media, and carrier waves.

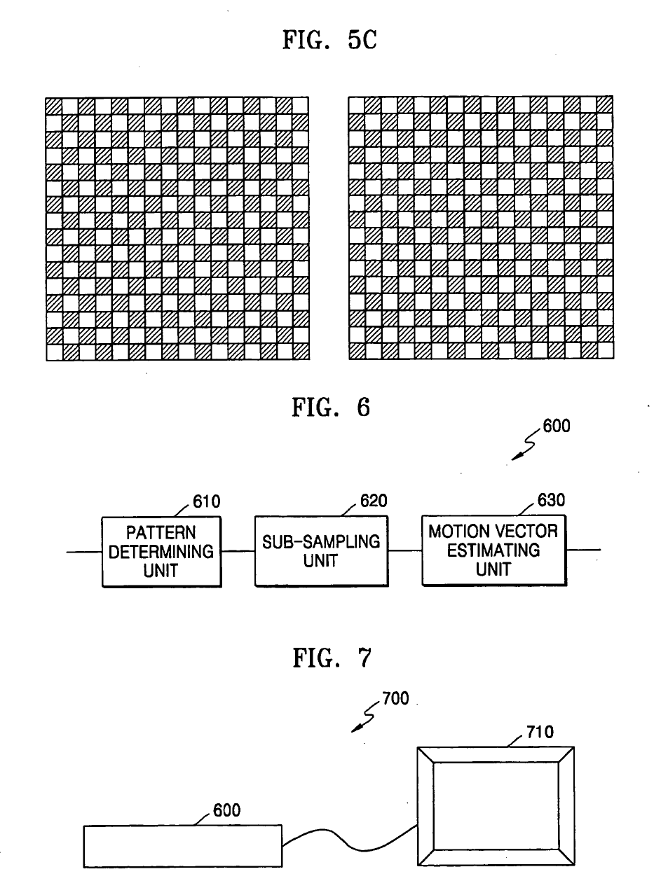

FIG. 7 is a diagram illustrating a display apparatus 700 for generating an image to be displayed. The display apparatus 700 includes at least one display device 710 to display the generated image and the motion vector estimating apparatus 600, as illustrated in FIG. 6. The motion vector estimating apparatus 600 provides a calculated motion vector to the at least one display device 710 so that an image is displayed. The display device 710 may include a television monitor, a computer monitor, etc. It is further understood that the display device 710 may be located inside of or integral with the display apparatus 700.

As described above, according to the invention, it is possible to avoid deterioration of the image quality and reduce the amount of calculation into a half or less of (2sx+1)×(2sy+1) in estimating a motion vector of a macroblock.

Although a few embodiments of the present invention have been shown and described, it would be appreciated by those skilled in the art that changes may be made in these embodiments without departing from the principles and spirit of the invention, the scope of which is defined in the claims and their equivalents.

1. A motion vector estimating method comprising:
calculating correlation values corresponding to a plurality of correlation calculating patterns selected in accordance with types of a present image, and determining a correlation calculating pattern according to the calculated correlation values; and
selecting a sub-sampling pattern corresponding to the correlation calculating pattern, sub-sampling a present image block and a search area according to the selected sub-sampling pattern, and estimating a motion vector using the sub-sampled present image block and the search area.

2. The method as claimed in claim 1, further comprising;
converting the estimated motion vector into a size corresponding to a size of the search area prior to the sub-sampling of the present image block.

3. The method as claimed in claim 1, wherein the calculating the correlation values and the determining the correlation calculating pattern further comprises;
calculating the correlation values of a predetermined pattern selected depending upon whether the present image is an interlaced image or a progressive image; and
selecting a pattern having the smallest calculated correlation value.

4. The method as claimed in claim 3, wherein the calculating the correlation values of the predetermined pattern selected further comprises:
calculating the correlation values of horizontal and diagonal patterns when the present image is the progressive image.

5. The method as claimed in claim 3, wherein the selecting the pattern having the smallest calculated correlation value further comprises:
calculating the correlation values of vertical, horizontal and diagonal patterns when the present image is the progressive image.

6. The method as claimed in claim 1, wherein the selecting the sub-sampling pattern corresponding to the correlation calculating pattern further comprises:
sub-sampling the present image block and the search area by discarding pixels in even lines or odd lines when the determined correlation calculating pattern is a horizontal or vertical pattern; and
estimating the motion vector of the sub-sampled search area.

7. The method as claimed in claim 1, wherein the selecting the sub-sampling pattern corresponding to the correlation calculating pattern further comprises:
sub-sampling the present image block and the search area by alternately discarding even and odd pixels on every line when the determined correlation calculating pattern is a diagonal pattern; and
estimating the motion vector of the sub-sampled search area.

8. The method as claimed in claim 6, wherein the estimating the motor vector of the sub-sampled search area further comprises:
estimating the motion vector by calculating sums of absolute differences (SADs) between the pixels.

9. The method as claimed in claim 7, wherein the estimating the motor vector of the sub-sampled search area further comprises:
estimating the motion vector by calculating sums of absolute differences (SADs) between the pixels.

10. A motion vector estimating apparatus comprising:
a pattern determining unit that calculates correlation values corresponding to a plurality of correlation calculating patterns selected in accordance with types of a present image, and determines a correlation calculating pattern according to the calculated correlation values;
a sub-sampling unit that selects a sub-sampling pattern corresponding to the determined correlation calculating pattern, and sub-samples a present image block and a search area; and
a motion vector estimating unit that estimates a motion vector of the sub-sampled image block and the sub-sampled search area.

11. The apparatus as claimed in claim 10, wherein the motion vector estimating unit converts the estimated motion vector into a size corresponding to a size of the search area prior to the sub-sampling of the present image block.

12. The apparatus as claimed in claim 10, wherein the pattern determining unit calculates correlation values of a predetermined pattern selected according to whether the present image is an interlaced image or a progressive image and selects a pattern having the smallest calculated correlation value.

13. The apparatus as claimed in claim 10, wherein the sub-sampling unit sub-samples the present image block and the search area by discarding pixels in even lines or odd lines when the determined correlation calculating pattern is a horizontal or vertical pattern, and sub-samples the present image block and the search area by alternately discarding even and odd pixels on every line when the determined correlation calculating pattern is a diagonal pattern.

14. The apparatus as claimed in claim 10, wherein the motion vector estimating unit estimates the motion vector by calculating sums of absolute differences (SADs) between the pixels.

15. A computer readable recording medium storing a program, having a motion vector estimating method to be performed by a computer, the method comprising:
calculating correlation values corresponding to a plurality of correlation calculating patterns selected in accordance with types of a present image, and determining a correlation calculating pattern on the basis of a calculation result; and
selecting a sub-sampling pattern corresponding to the determined correlation calculating pattern, sub-sampling a present image block and a search area according to the selected sub-sampling pattern, and estimating a motion vector using the sub-sampled present image block and the search area.

16. A method of estimating a motion vector of a macroblock by performing a block matching process on a search area, comprising:
defining a predetermined search area;
selectively removing pixel values and calculating sums of absolute differences from the selected remaining pixel values of an image block and the predetermined search area while moving the image block over the predetermined search area; and
detecting an image block having the smallest sum of absolute difference, wherein the estimated motion vector of the macroblock is determined from the detected image block.

17. The method of estimating a motion vector as claimed in claim 16, wherein the calculating sums of absolute differences further comprises:
moving the image block over the predetermined search area by a first predetermined number of pixels in a first direction and a second predetermined number of pixels in a second direction such that the sums of absolute differences is calculated for all of the pixels in the search area.

18. The method of estimating a motion vector as claimed in claim 16, wherein the sums of absolute differences is calculated while moving the image block over the predetermined search area.

19. The method of estimating a motion vector as claimed in claim 16, wherein the sums of absolute differences is calculated a number of times equivalent to twice a number of pixels searched in a first direction plus one, multiplied by twice a number of pixels searched in a second direction plus one.

20. A display apparatus for generating an image to be displayed and having the motion vector estimating device as claimed in claim 10, further comprising:
a display device to display the generated image,
wherein a position of the image to be displayed is determined by the estimated motion vector.

21. The display apparatus as claimed in claim 20, wherein the types of the present image include either an interlaced image or a progressive image such that such that appropriate correlation calculating patterns are used to calculate the correlation values and one correlation calculating pattern is selected according to the calculated results.

22. The display apparatus as claimed in claim 21, wherein when the input image is the interlaced image, horizontal and diagonal direction correlation calculating patterns are used to calculate the correlation value, and when the input image is the progressive image, horizontal, vertical, and diagonal direction correlation calculating patters are used to calculate the correlation value.

23. The display apparatus as claimed in claim 22, wherein the one correlation calculating pattern selected by the pattern determiner is the correlation calculating pattern having the smallest correlation value of the calculated results.

24. The display apparatus as claimed in claim 22, wherein the calculation of correlation values is performed using a difference in brightness between adjacent pixels.

25. The display apparatus as claimed in claim 21, wherein the motion vector estimator calculates sums of absolute differences from pixel values of the image block and the predetermined search area while the image block is moved over the predetermined search area, and detects an image block having the smallest sum of absolute difference, such that the estimated motion vector is determined from the image block.

26. The display apparatus as claimed in claim 25, wherein the motion vector estimator calculates the sums of absolute differences by moving the image block over the predetermined search area by a first predetermined number of pixels in a first direction and a second predetermined number of pixels in a second direction such that the sums of absolute differences is calculated for all of the pixels in the predetermined search area.

27. The display apparatus as claimed in claim 25, wherein the motion vector estimator calculates the sums of absolute differences when the image block moves over the predetermined search area.

28. The display apparatus as claimed in claim 25, wherein the motion vector estimator calculates the sums of absolute differences a number of times equivalent to twice a number of pixels searched in a first direction plus one, multiplied by twice a number of pixels searched in a second direction plus one.

29. A plurality of sub-sampled patterns for calculating a motion vector according to a type of picture while encoding and/or decoding a moving picture, comprising:
a first set of sub-sampled patterns corresponding to a first type of picture, each of the sub-sampled patterns in the first set having a different correlation calculating pattern; and
a second set of sub-sampled patterns corresponding to a second type of picture, each of the sub-sampled patterns in the second set having a different correlation calculation pattern,
wherein pixels are selectively removed from the first and second sets of sub-sampled patterns such that the motion vector is calculated by calculating the sums of absolute differences between the pixels.

30. The plurality of sub-sampled patterns as claimed in claim 29, wherein the first type of picture is a progressive picture and the second type of picture is an interlaced picture.

31. The plurality of sub-sampled patterns as claimed in claim 30, wherein each of the sub-sampled patterns in the first set comprises one of a horizontal correlation calculating pattern, a vertical correlation calculating pattern, and a diagonal correlation calculating pattern, respectively, and each of the sub-sampled patterns in the second set comprises one of a horizontal correlation calculating pattern and a diagonal correlation calculating pattern, respectively.

32. The plurality of sub-sampled patterns as claimed in claim 31, wherein the pixels are selectively removed from the first and second sets of sub-sampled patterns by removing pixels on even or odd lines of the horizontal and vertical correlation calculating patterns, and by alternatively removing even and odd pixels on every line of the diagonal correlation calculating pattern.
